(19) United States
(12) Patent Application Publication
(10) Pub. No.: US 2016/0161372 A1
(43) Pub. Date: Jun. 9, 2016

(54) VEHICLE PROTOTYPE FOR CRASH TEST

(71) Applicant: HYUNDAI MOTOR COMPANY, sEOUL (KR)

(72) Inventors: Soo Heung EOM, Hwaseong-si, Gyeonggi-do (KR); Hyun Sik KIM, Seoul (KR); Joo Nam KIM, Yongin-si, Gyeonggi-do (KR); Seong Su SHIN, Seoul (KR)

(73) Assignee: HYUNDAI MOTOR COMPANY, Seoul (KR)

(21) Appl. No.: 14/731,340

(22) Filed: Jun. 4, 2015

(30) Foreign Application Priority Data
Dec. 9, 2014 (KR) 10-2014-0175822

(51) Int. Cl. G01M 17/007

(52) U.S. Cl. CPC G01M 17/0078

(57) ABSTRACT

A vehicle prototype for a crash test includes a vehicle coupling part connected to a test specimen, which is a part of an actual vehicle body. A main body is connected to the actual vehicle coupling part and crashes together with the test specimen.

### CROSS-REFERENCE TO RELATED APPLICATION

This application is based on and claims the benefit of priority to Korean Patent Application No. 10-2014-0175822, filed on Dec. 9, 2014 in the Korean Intellectual Property Office, the disclosure of which is incorporated herein in its entirety by reference.

### TECHNICAL FIELD

The present disclosure relates to a vehicle prototype for a crash test, and more particularly, to a vehicle prototype for a crash test capable of shortening crash test costs and time.

### BACKGROUND

A crash test, as one of vehicle performance tests, measures safety performance of an actual vehicle by crashing the vehicle on a proving ground under a given regulation. The crash test is conducted using various sensors which are attached to the vehicle. The crash test vehicle, which includes all vehicle parts assembled and a crash gest dummy therein, crashes with a wall or the like under the regulation.

The above-mentioned crash test is suitable for an integrated safety performance test of the vehicle in order to obtain regulation certification. However, since the crash test consumes high cost and time, it is not suitable for testing only some of the vehicle parts

### SUMMARY

The present disclosure has been made to solve the above-mentioned problems occurring in the prior art while advantages achieved by the prior art are maintained intact.

An aspect of the present inventive concept provides shortening crash test time of a vehicle.

Another aspect of the present inventive concept provides reducing crash test costs of a vehicle.

However, objects of the present disclosure are not limited to the objects described above, and other objects that are not described above may be clearly understood by those skilled in the art from the following description.

According to an exemplary embodiment of the present inventive concept, a vehicle prototype for a crash test includes a vehicle coupling part connected to a test specimen, which is a part of an actual vehicle body. A main body is connected to the actual vehicle coupling part and crashes together with the test specimen.

Specific matters of other exemplary embodiments will be included in a detailed description and the accompanying drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a concept view of a vehicle prototype for a crash test according to an exemplary embodiment of the present inventive concept.

FIG. 2 is a perspective view of the vehicle prototype for the crash test according to the exemplary embodiment of the present inventive concept.

FIG. 3 is a perspective view showing the vehicle prototype of FIG. 2 in more detail.

FIG. 4 is a front view of an actual vehicle coupling part of FIG. 2.

FIG. 5 is a side view of the vehicle prototype of FIG. 2.

FIG. 6A is a front view of a weight.

FIG. 6B is a perspective view showing the weight fixed to the vehicle prototype.

### DETAILED DESCRIPTION

Advantages and features of the present disclosure and methods to achieve them will be elucidated from exemplary embodiments described below in detail with reference to the accompanying drawings.

However, the present disclosure is not limited to exemplary embodiments disclosed below, but will be implemented in various forms. The exemplary embodiments of the present inventive concept are provided so that those skilled in the art can easily understand the scope of the present disclosure. Therefore, the present disclosure will be defined by the scope of the appended claims. Like reference numerals throughout the specification denote like elements.

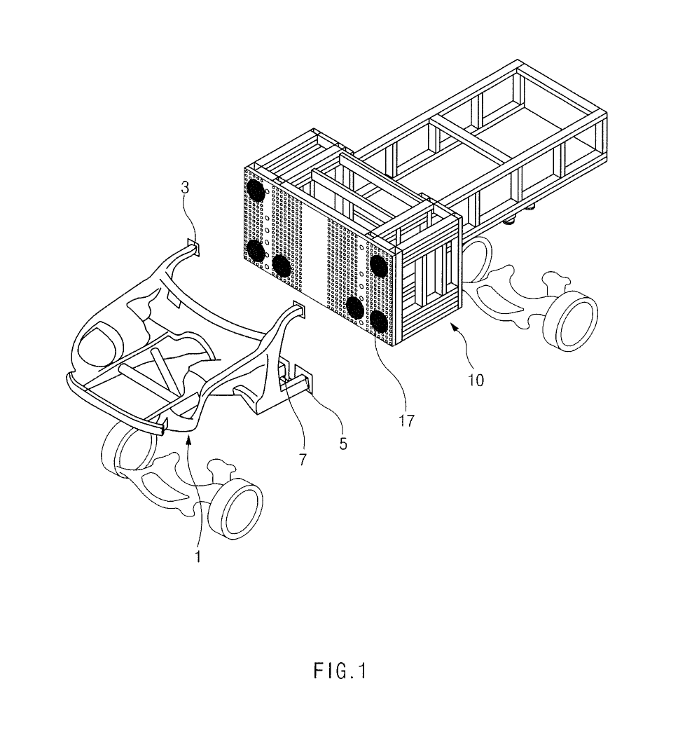

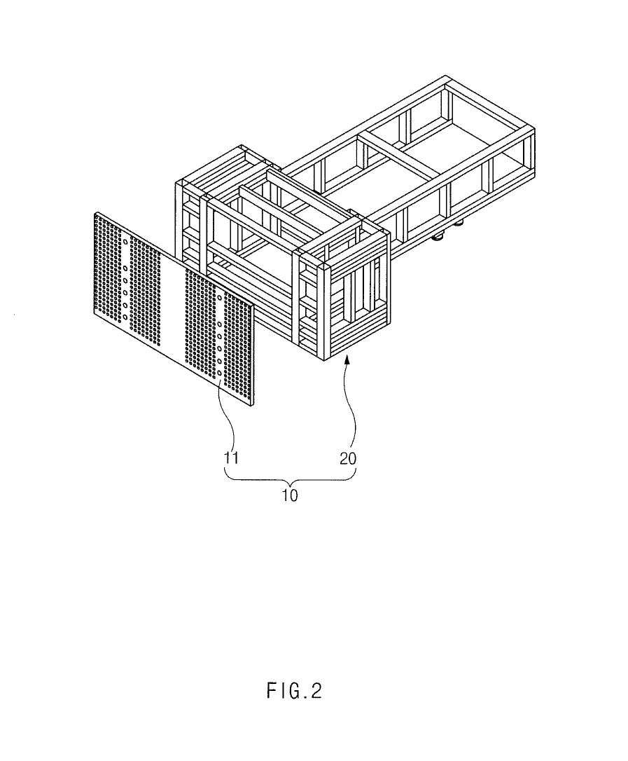

FIG. 1 is a concept view of a vehicle prototype 10 for a crash test according to an exemplary embodiment of the present inventive concept. FIG. 2 is a perspective view of the vehicle prototype 10 for the crash test according to the exemplary embodiment of the present inventive concept.

Referring to FIGS. 1 and 2, the vehicle prototype 10 includes an actual vehicle coupling part 11 to which a test specimen 1, which is a portion of an actual vehicle body, is connected. A main body 20 is connected to the actual vehicle coupling part 11 so as to be crashed together with the test specimen 1.

The actual vehicle coupling part 11 is coupled to A pillar 3, a center floor member 5, and a side sill 7, which configure a main load path of the test specimen 1.

The vehicle prototype 10 for the crash test according to the present disclosure further includes a plurality of sensors 17 which measure a load transferred from the test specimen 1 and tare mounted to a part connected to the main load path of the actual vehicle coupling part 11.

The plurality of sensors 17 measure acceleration and stress in X, Y, and Z directions.

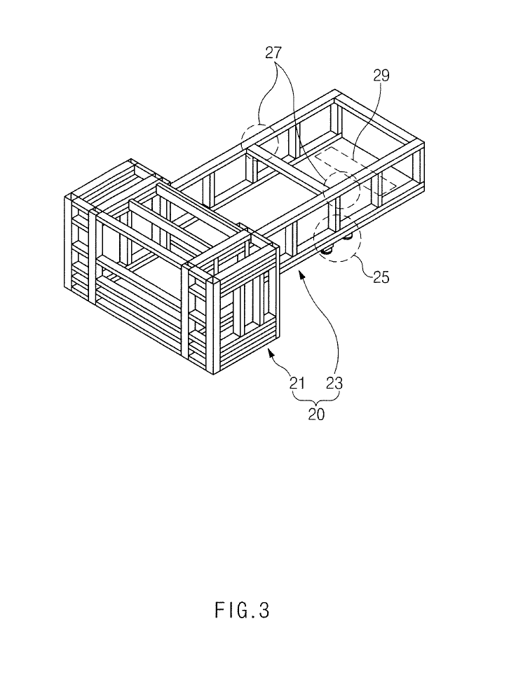

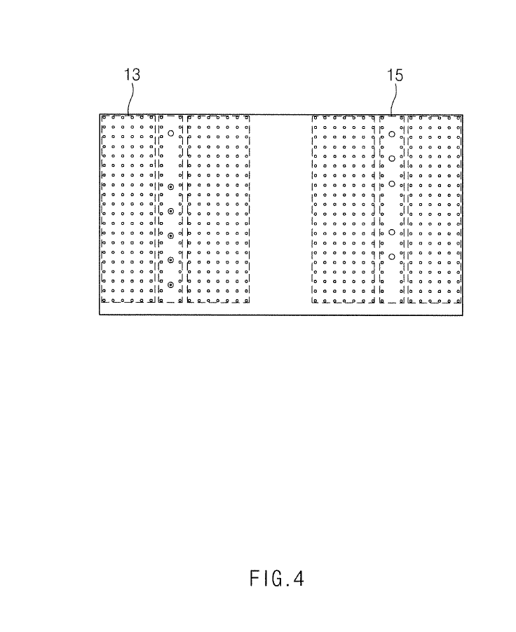

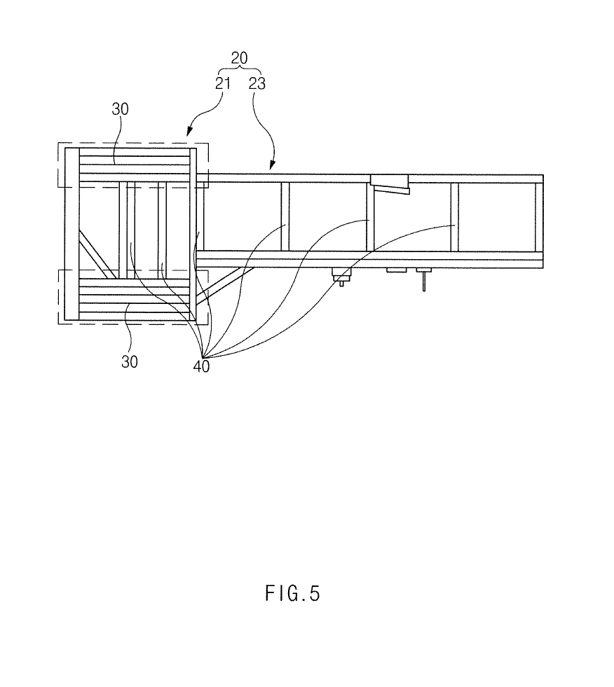

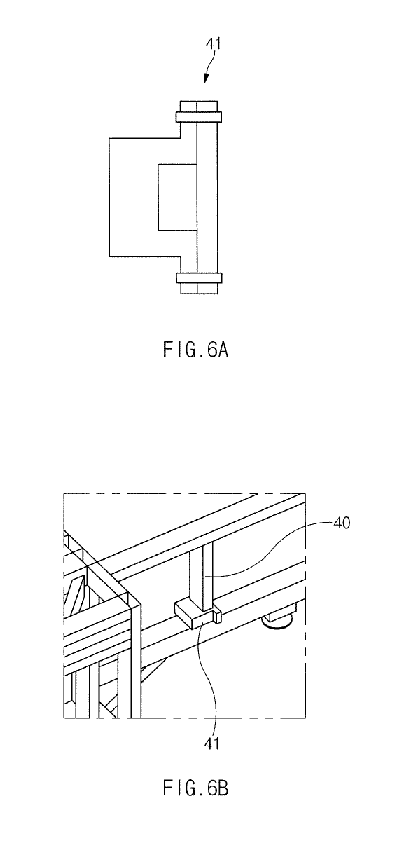

FIG. 3 is a perspective view showing the vehicle prototype 10 for the crash test of FIG. 2 in more detail. FIG. 4 is a front view of the actual vehicle coupling part 11 of FIG. 2. FIG. 5 is a side view of the vehicle prototype 10 for the crash test of FIG. 2. FIG. 6A is a front view of a weight 41, and FIG. 6B is a perspective view showing the weight 41 fixed to the vehicle prototype 10 for the crash test.

Referring to FIGS. 3 to 6B, the actual vehicle coupling part 11 and the test specimen 1 are coupled by bolts. The actual vehicle coupling part 11 includes a plate to which the test specimen 1 is connected and bolting holes 13 into which the bolts are inserted.

The bolting holes 13 are formed in the plate entirely so that the test specimens 1 corresponding to a small-size vehicle, a medium size vehicle, and a large size vehicle can be mounted.

The actual vehicle coupling part 11 has connection holes 15 which have a diameter larger than that of the bolting hole 13 and couples the actual vehicle coupling part 11 to the main body 20.

The main body 20 includes a front part 21 fixedly supporting the actual vehicle coupling part 11, and a rear part 23 connected to a rear side of the front part 21. The rear part 23 has rear wheel connecting parts 25 to which a rear wheel is connected.

The front part 21 and the rear part 23 have at least one of crash responding members 30 which are aligned in a forward and backward direction of the vehicle and formed in several layers. Weight fixing members 40 are disposed in a vertical direction of the vehicle and coupled to the weight 41.

The rear wheel connecting parts 25 are formed at a lower side of the rear part 23 and rear crash absorbing parts 27 formed at an upper side of the rear part 23.

The crash responding members 30 firmly hold the vehicle prototype 10 at the time of the crash test, thereby repeating the crash test with the vehicle prototype 10.

The weight fixing members 40 suspend the weight 41. Since the weight fixing members 40 are present throughout the vehicle prototype 10 for the crash test, an actual vehicle weight distribution condition of all vehicles may be similarly satisfied.

The rear wheel connecting parts 25 have grooves cut therein. The rear wheel connecting parts 25 are manufactured and used according to a rear wheel condition of a vehicle to be tested.

The rear part 23 has a flat measuring instrument mounting part 29 so that a measuring instrument may be mounted on the upper side of the rear wheel connecting part 25. Features of a crash test method using the vehicle prototype 10 for the crash test according to an exemplary embodiment of the present inventive concept as described above will be described as follows.

First, at the time of the test, portions that are not to be tested and adjacent parts thereof are simplified. Matters that may influence throughout the test such as front and rear shaft weight distribution, and the like are maximally considered during the simplification process. The parts which are not largely damaged at the time of the test are again used in a next test.

According to the present disclosure, in order to reproduce the same load path as the actual vehicle load path, parts (A pillar 3, center floor member 5, and side sill 7) configuring a main load path of the actual vehicle except for the parts to be tested are coupled to the vehicle prototype 10, and the sensors 17 are installed at the coupled portions.

By coupling the vehicle prototype 10 for the crash test and the actual vehicle in this way, the same load path as the actual vehicle may be reproduced while using the vehicle prototype 10 for the crash test. In addition, since a crash phenomenon similar to an actual vehicle experiment occurs and the sensors 17 are mounted to the coupled portions, the trend of the load path passing to the vehicle prototype 10 for the crash test through the actual vehicle coupling part 11 may be observed, thereby easily detecting behaviors of the non-test parts.

When the vehicle prototype 10 for the crash test according to an exemplary embodiment of the present inventive concept described above is used, the load path of an existing actual vehicle may be reproduced. In addition, since the vehicle prototype 10 for the crash test and the test specimen 1 are connected by the bolts, the connection may be easy.

In addition, according to the present disclosure, since the actual vehicle and the vehicle prototype 10 for the crash test are all coupled by a bolting fastening and the bolting holes 13 and the fastening holes are formed throughout the actual vehicle coupling part 11, it is limited to only one specification, but may be commonly used for all specifications. Therefore, once the vehicle prototype 10 for the crash test is fabricated, it may be reused as long as it is not broken.

In addition, the vehicle prototype 10 for the crash test includes the actual vehicle coupling part 11 and the main body 20. When the actual vehicle coupling part 11 is damaged during the repeated crash test, only the damaged actual vehicle coupling part 11 can be easily replaced.

The bolting holes 13 for connecting the actual vehicle are formed at equidistant intervals (30 mm×30 mm to 50 mm×50 mm). Since the vehicle prototype 10 for the crash test is coupled to the actual vehicle using various bolting holes 13, an actual vehicle experiment of various data may be performed by one vehicle prototype 10 for the crash test.

As described above, according to the exemplary embodiments of the present inventive concept, the following advantages may be provided.

First, since the complete vehicle order and rework processes are omitted and the vehicle prototype is replaced, the test time may be shortened.

Second, since only an inexpensive vehicle prototype and interest parts are manufactured and assembled to perform the test instead of using the complete vehicle, the costs may be reduced.

However, effects of the present disclosure are not limited to the effects described above, and other effects that are not described above may be clearly understood by those skilled in the art from the claims.

Although the exemplary embodiments of the present inventive concept have been disclosed for illustrative purposes, those skilled in the art will appreciate that various modifications, additions, and substitutions are possible, without departing from the scope and spirit of the present disclosure as disclosed in the accompanying claims. Accordingly, such modifications, additions, and substitutions should also be understood to fall within the scope of the present disclosure.

What is claimed is:

1. A vehicle prototype for a crash test, the vehicle prototype comprising:
a vehicle coupling part connected to a test specimen; and
a main body connected to the vehicle coupling part so that the main body crashes together with the test specimen,
wherein the vehicle coupling part is an actual vehicle body part.

2. The vehicle prototype according to claim 1, wherein the vehicle coupling part is coupled to an A pillar, a center floor member, and a side sill of the test specimen, which configure a main load path of the test specimen.

3. The vehicle prototype according to claim 2, further comprising a plurality of sensors configured to measure a load transferred from the test specimen,
wherein the plurality of sensors are mounted to the vehicle coupling part.

4. The vehicle prototype according to claim 3, wherein the plurality of sensors measure acceleration and stress in X, Y, and Z directions.

5. The vehicle prototype according to claim 1, wherein the vehicle coupling part and the test specimen are coupled to each other by bolts, and
the vehicle coupling part has a plate to which the test specimen is attached and has bolting holes into which the bolts are inserted.

6. The vehicle prototype according to claim 5, wherein the bolting holes are formed throughout the plate to mount the test specimen for various vehicle sizes.

7. The vehicle prototype according to claim 5, wherein the actual vehicle coupling part comprises connection holes having a diameter larger than that of the bolting holes and coupling the main body.

8. The vehicle prototype according to claim 1, wherein the main body includes a front part fixedly supporting the vehicle coupling part and a rear part connected to a rear side of a front part, and
wherein the rear part has rear wheel connecting parts to which a rear wheel is connected.

9. The vehicle prototype according to claim 8, wherein the front part and the rear part comprises:
at least one of crash responding members aligned in a forward and backward direction of the vehicle prototype and formed in a plurality of layers; and
weight fixing members aligned in a vertical direction of the vehicle prototype and coupled to a weight.

10. The vehicle prototype according to claim 8, wherein the rear wheel connecting parts are formed at a lower side of the rear part and rear crash absorbing parts are formed at an upper side of the rear part.

11. The vehicle prototype according to claim 8, wherein the rear part has a flat measuring instrument mounting part to mount a measuring instrument on an upper side of the rear wheel connecting parts.
